(19) United States
(12) Patent Application Publication
(10) Pub. No.: US 2010/0188670 A1
(43) Pub. Date: Jul. 29, 2010

(54) IMAGE PROCESSING APPARATUS, IMAGE PROCESSING METHOD AND PROGRAM EXECUTING THE IMAGE PROCESSING METHOD

(75) Inventor: Ritsuko Otake, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/688,304

(22) Filed: Jan. 15, 2010

(30) Foreign Application Priority Data
Jan. 29, 2009 (JP) 2009-018731

(51) Int. Cl. G06K 15/02

(52) U.S. Cl. 358/1.2

(57) ABSTRACT

When an image including a pattern expressed by a collection of dots such as a copy-forgery-inhibited pattern and a two-dimensional code is reduced simply by sampling of pixels, the dots are closely arranged to make the reduced image appear to be dark as a whole, and the content thereof becomes difficult to understand. An image processing apparatus includes a reducing unit configured to reduce an image and a deleting unit configured to delete an additional image when the image includes the additional image which has information hidden therein at the time of reducing the image by the reducing unit.

### BACKGROUND OF THE INVENTION

1. Field of the Invention

The present invention relates to an image processing apparatus which handles pattern images such as a copy-forgery-inhibited pattern and a two-dimensional code, an image processing method, and a program executing the image processing method and a printing medium.

2. Description of the Related Art

There is conventionally known a technology (see Japanese Patent Laid-Open No. 2004-223854, for example) of printing a document by adding a copy-forgery-inhibited pattern image (image of a pattern constructed of a portion (latent image) which disappears when copied with a copying machine, and a portion (background) which is reproduced when copied) to the original document image at the time of printing the document, for the purpose of prevention of unauthorized copy. There is also known a technology in which additional information is converted into a one-dimensional code (for example, a bar code), and a two-dimensional code (for example, a QR code and a low visibility bar code), and the converted N-dimensional code is printed by being added to the original document image (for example, Japanese Patent Laid-Open No. 2002-305646 and Japanese Patent Laid-Open No. 2008-271110, for example).

The copy-forgery-inhibited pattern image and N-dimensional code as described above are images which are expressed by collections of dots (copy-forgery-inhibited pattern images and N-dimensional codes will be generically called additional images in the present specification). Therefore, if the image to which an additional image is added is reduced, many dots remain on the reduced image or the dots are emphasized, and it sometimes becomes difficult to grasp and recognize the original document image.

For example, when the image in which dots are periodically arranged as shown in FIG. 6 is simply reduced by performing sampling (thinning) of pixels for the image, the residual extent of the dots significantly changes depending on the phase at the time of sampling. FIG. 7A to 7B shows views showing how reduced screens differ depending on the difference in the phase at a sampling time. In FIG. 7A, the pixels corresponding to the shaded portions of sampling target areas 702 are sampled. In this case, pixels 701 which form dots on the original image do not remain, and therefore, on the reduced image, the pattern by the dots totally disappear as shown in FIG. 7B. In contrast with this, in FIG. 70, the pixels corresponding to the shaded portions of sampling target areas 704 are sampled. In this case, pixels 703 which form dots on the original image remain with a high probability, and therefore, on the reduced image thereof, the pattern by the dots appears with high density as shown in FIG. 7D.

In this way, when the image including the pattern expressed by the collection of dots such as a copy-forgery-inhibited pattern and a two-dimensional code is reduced simply by the sampling of pixels, the dots are closely arranged and make the reduced image appear to be dark as a whole. Therefore, there arises the problem that the content thereof becomes difficult to understand.

### SUMMARY OF THE INVENTION

In order to solve the above described problem, the present invention includes the following construction.

An image processing apparatus of the present invention comprises a reducing unit configured to reduce an image, and a deleting unit configured to delete an additional image in a case where the image includes the additional image which has information hidden therein at the time of reducing the image by the reducing unit.

Even when the image including the additional image constructed of a pattern expressed by a collection of dots such as a copy-forgery-inhibited pattern and a two-dimensional code is reduced, visibility of an original document can be stably secured on the reduced image.

Further features of the present invention will become apparent from the following description of exemplary embodiments with reference to the attached drawings).

### BRIEF DESCRIPTION OF THE DRAWINGS

FIG. 1 is a view showing an example of the appearance of a digital multi function peripheral according to the present invention;

FIG. 2 is a block diagram showing an example of the construction of a control unit of the digital multi function peripheral according to the present invention;

FIG. 3 is a diagram conceptually expressing tile data;

FIG. 4 is a block diagram showing the internal construction of a scanner image processing unit;

FIG. 5 is a block diagram showing the internal construction of a printer image processing unit;

FIG. 6 is a view showing an example in which dots are periodically arranged;

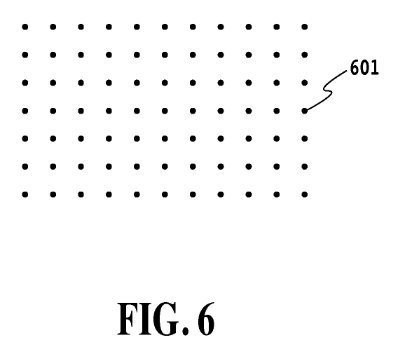

FIG. 7A to 7D are view showing one example of how reduced screens differ depending on a difference in phase at the time of sampling dots;

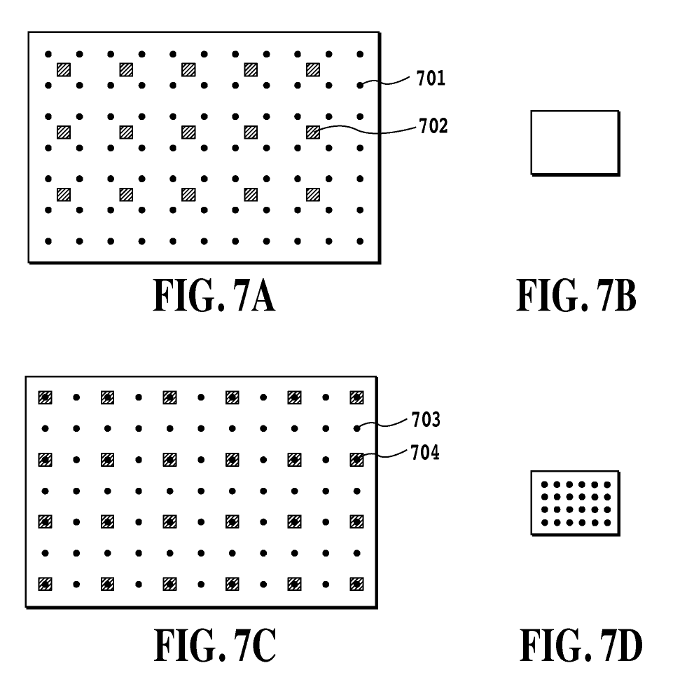

FIG. 8 is diagrams comparing a case of printing a report print with a reduced image by using the digital multi function peripheral according to the present embodiment with a case of printing it by using the conventional technology;

FIG. 9 is a partial enlarged view of a document image to which a low visibility bar code is added;

FIG. 10 is a diagram showing an example of an arrangement pattern of dots in the low visibility bar code;

FIG. 11 is a block diagram showing components of an information analyzing unit;

FIG. 12 is a diagram explaining a detection method of a dot in a dot detecting unit;

FIG. 13 is a graph explaining a principle of removing dots which can not constitute a low visibility bar code;

FIG. 14 is a flowchart showing a series of processing steps from scanning to printing of a document of the digital multi function peripheral according to a first embodiment;

FIG. 15A to 15D are diagram visually explaining the principle of thinning processing;

FIG. 16 is an example of an image to which a copy-forgery-inhibited pattern is added;

FIG. 17 is an example of arrangement of dots in a copy-forgery-inhibited pattern;

FIG. 18 is a flowchart showing a series of processing steps from scanning to printing of a document of a digital multi function peripheral according to a second embodiment; and

FIG. 19A to 19C are diagram explaining the principle of analyzing processing of a copy-forgery-inhibited pattern.

### DESCRIPTION OF THE EMBODIMENTS

Hereinafter, embodiments in the present invention will be described with reference to the accompanying drawings.

### First Embodiment

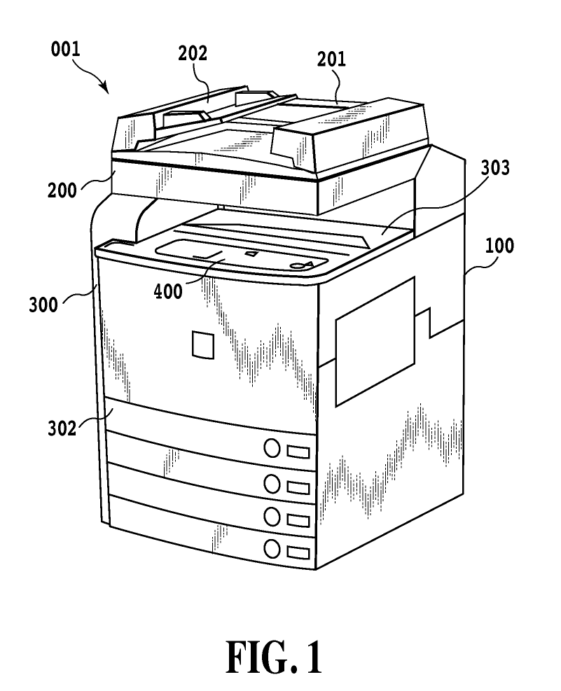

FIG. 1 is a view showing the appearance of a digital multi function peripheral 001 according to the present embodiment.

A control unit 100 is a control unit for performing control of an entire system including a scanner 200, a printer 300 and the like.

The scanner 200 performs scanning for a document image by a three-line CCD provided with color filters of R (red), G (green) and B (blue) not illustrated, or a four-line CCD with addition of BK (black) to them. The electric charge amount obtained by the CCD is converted into an electric signal expressing RGB color image data or/and gray scale image data. When documents are set on a tray 202 of a document feeder 201, and a reading start instruction is given from an operation unit 400, a CPU 103 which will be described later gives an instruction to the scanner 200, and the feeder 201 feeds the documents one by one to perform an operation of reading the document images.

The printer 300 is a unit which prints raster image data on paper. As a printing method, any method such as an electronic photograph method or an inkjet method is used. The print operation is started by the instruction from the control unit CPU 103. A paper cassette 302 is a unit in which sheets of paper are set for being supplied to the printer, and has a plurality of paper supply stages in some cases so that different paper sizes or different paper orientations can be selected at printing. The paper on which the printing is completed is discharged to a paper output tray 303.

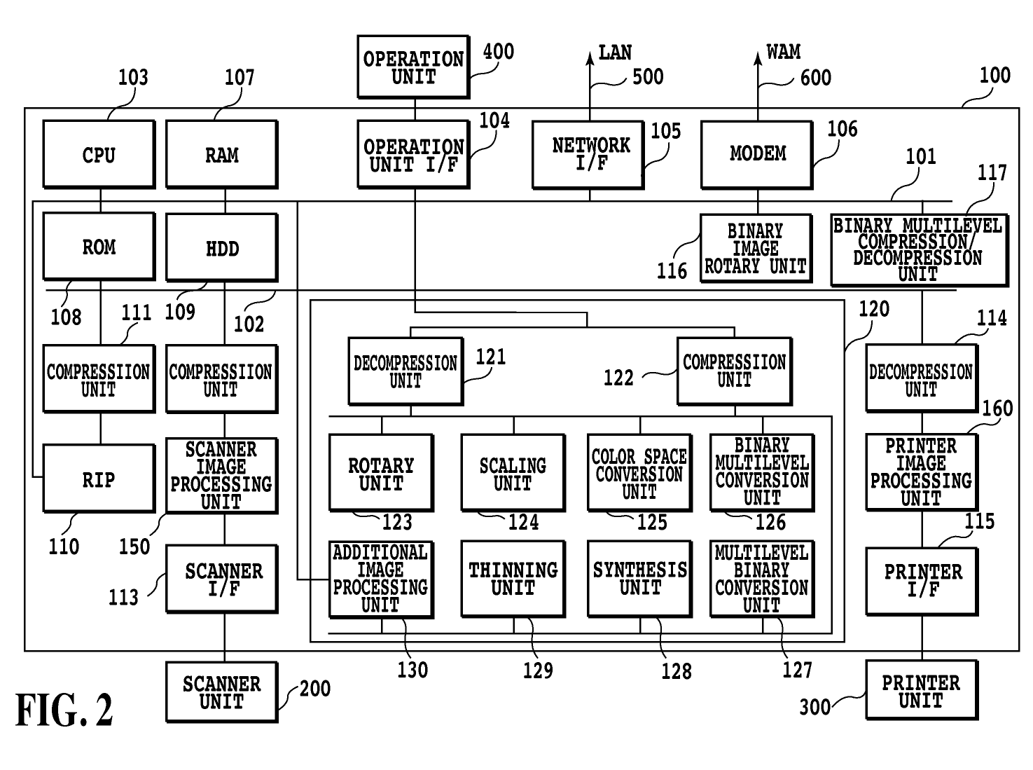

FIG. 2 is a block diagram showing the construction of the control unit 100 of the digital multi function peripheral 001.

The control unit 100 is electrically connected to the scanner unit 200 and the printer unit 300, and on the other hand, is connected to a computer and the other external devices not illustrated through a LAN 500 and a WAN 600. Thereby, external image data and device information can be inputted and outputted.

The CPU 103 performs centralized control of access to various devices which are connected thereto based on control programs or the like stored in a ROM 108, and also performs centralized control of various kinds of processing executed inside the control unit. A RAM 107 is a system work memory for the CPU 103 to operate, and is also a memory for temporarily storing image data. The RAM 107 is constructed of an involatile RAM which saves the stored content even after the power supply is turned off, and a DRAM in which the stored content is deleted after the power supply is turned off. The ROM 108 stores a boot program for a device and the like therein. An HDD 109 is a hard disk drive, and can store system software and image data therein.

An operation unit interface 104 is an interface unit for connecting a system bus 101 and an operation unit 400. The operation unit interface 104 receives the image data to be displayed on the operation unit 400 from the system bus 101 and outputs the received image data to the operation unit 400, and further, outputs the information inputted from the operation unit 400 to the system bus 101.

A network interface 105 is connected to the LAN 500 and the system bus 101, and receives and outputs information. A modem 106 is connected to the WAN 600 and the system bus 101, and receives and outputs information. A binary image rotary unit 116 converts the direction of binary image data before transmission. A binary image compression/decompression unit 117 converts the resolution of the binary image data before transmission into predetermined resolution and the resolution corresponding to the capability of a reception-side device. On compression and decompression, methods such as JBIG, MMR, MR and MH methods are used. An image bus 102 is a transmission path for exchanging image data, and is constructed of a PCI bus or IEEE1394.

A scanner image processing unit 150 performs correcting, processing and editing to the image data received from the scanner unit 200 through a scanner interface 113. A detail of the processing which is executed in the scanner image processing unit 150 will be described later.

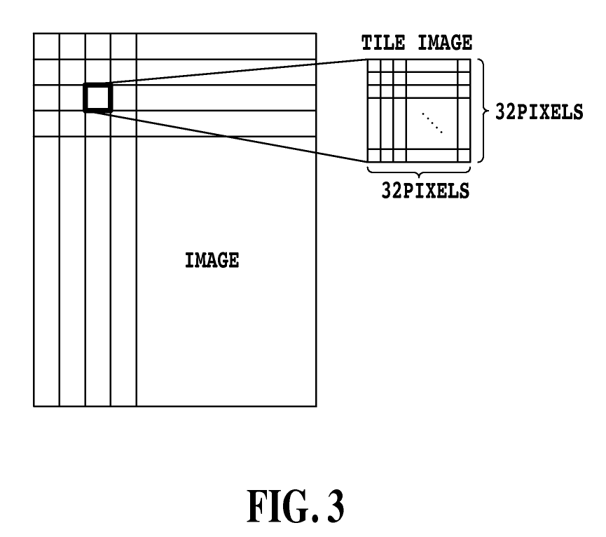

Compression units 111 and 112 receive image data, and divide the image data into blocks each having 32 pixels×32 pixels. The image data of 32×32 pixels is called tile data. FIG. 3 conceptually shows the tile data. The area corresponding to the tile data in a document (paper medium before read) is called a tile image. To the tile data, average brightness information in the block of 32×32 pixels and the coordinate positions on the document of the tile image are added as header information. Further, the compression unit 112 compresses the image data constructed of a plurality of tile date. A decompression unit 114 decompresses image data constructed of a plurality of tile data, and thereafter, performs raster development of the decompressed image data to send the image data to a printer image processing unit 160.

The printer image processing unit 160 executes various kinds of image processing to the image data sent from the decompression unit 114. The image data after the image processing is outputted to the printer unit 300 through a printer interface 115. A detail of the processing which is executed in the printer image processing unit 160 will be described later.

An image converting unit 120 executes predetermined conversion processing to image data, and is constructed of each of units 121 to 130 shown as follows.

A decompression unit 121 decompresses the image data received therein. A compression unit 122 compresses the image data received therein. A rotary unit 123 rotates the image data received therein. A scaling unit 124 executes resolution conversion processing (for example, converts 600 dpi into 200 dpi) to the image data which it receives. A color space converting unit 125 converts the color space of the image data received therein. In the color space converting unit 125, brightness-density conversion processing (RGB to CMY), and output color correction processing (CMY to CMYK) are further carried out. A binary multilevel converting unit 126 converts the image data of two gradations received therein into the image data of 256 gradations. In contrast with this, a multilevel binary converting unit 127 converts the image data of 256 gradations received therein into the image data of two gradations by the technique of error dispersion processing or the like. A synthesizing unit 128 synthesizes or allocates two image data received therein and generates one sheet of image data. When two image data are synthesized, there is applied a method for setting the average value of the brightness values which the pixels to be synthesized have as a synthesized brightness value or a method for setting the brightness value of a brighter pixel at a brightness level as the brightness value of the pixels after synthesized. Further, a method for setting a darker pixel as the pixel after synthesized may be also used. Further, a method for determining the brightness value after synthesized by OR operation, AND operation, EXCLUSIVE-OR operation and the like of the pixels to be synthesized may be applied. These synthesizing methods are known methods. Further, for allocation, a plurality of image data which the synthesizing unit 128 receives are allocated by the method incorporated in the control program stored in the ROM 108 in advance to generate a sheet of image data. The allocating method is determined for each kind of job in advance in such a manner that, for example, at the time of report printing, the image obtained by reducing a scan image and text information within the predefined text length are stuck onto respective fixed areas and the like. A thinning unit 129 executes processing of deleting an additional image from the image data received therein, that is, thinning the pixels in the lines where the dots constituting the additional image are located. An additional image processing unit 130 executes processing of dot detection, analysis, decoding and the like of the additional image. The additional image processing unit 130 executes processing of generating a predetermined additional image, and detecting and decoding the additional image pattern from the image data received therein to acquire the original information. Further, the additional image processing unit 130 is also connected to the system bus 101 and can notify the CPU 103 of the result of decoding processing. The additional image processing unit 130 includes an information analyzing unit 131 as an internal module for detecting and analyzing an additional image, and this will be described later.

An RIP 110 receives intermediate data which is generated based on PDL data transmitted from an external computer or the like not illustrated which is connected onto the LAN 500 to generate multilevel bit map data.

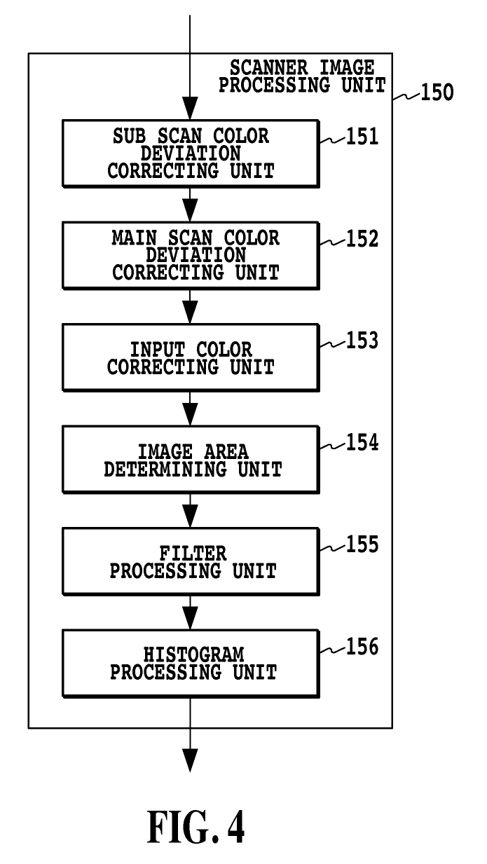

FIG. 4 is a block diagram showing the internal construction of a scanner image processing unit 150.

Reference numeral 151 designates a sub-scan color deviation correcting unit which corrects a color deviation of an input image in a sub scan direction (deviation of printing of each of RGB in the sub scan direction), and executes processing of performing convolution operation of 1×5 size for each color of image data, for example.

Reference numeral 152 designates a main-scan color deviation correcting unit which corrects a color deviation of an input image in a main scan direction (deviation of printing of each of RGB in the main scan direction), and executes processing of performing convolution operation of 5×1 size for each color of image data, for example.

Reference numeral 153 designates an input color correcting unit, which corrects image data containing the characteristics of the scanner to standard data, and executes processing of converting the color space of an input image into any color space, for example.

Reference numeral 154 designates an image area determining unit which discriminates the image kind in each pixel or each area in an input image. For example, the image area determining unit 154 discriminates the respective pixels which constitute the image kinds such as photograph portion/character portion, chromatic portion/achromatic portion and the like in the input image, and generates attribute flag data indicating the kind thereof for a pixel unit.

Reference numeral 155 designates a filter processing unit which arbitrarily corrects spatial frequency characteristics of an input image, and performs a convolution operation of size of 7×7, for example.

Reference numeral 156 designates a histogram processing unit which samples and counts the image signal data in an input image, and makes a determination on whether the input image is a color image or a monochrome image, and a determination on the background color level of the input image, for example.

The processing in the scanner image processing unit 150 does not necessarily use all of the sub-scan color deviation correcting unit 151 to the histogram processing unit 156, and the other image processing modules may be added. Further, the sequence of processing of the sub-scan color deviation correcting unit 151 to the histogram processing unit 156 shown in FIG. 4 is only an example, and each processing can be executed in any sequence.

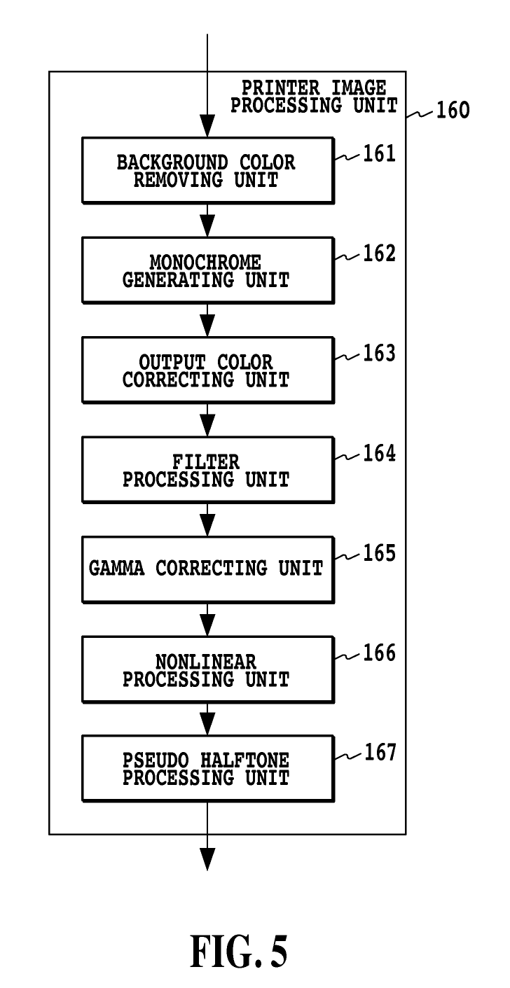

FIG. 5 is a block diagram showing the internal construction of the printer image processing unit 160.

Reference numeral 161 designates a background color removing unit which removes the background color of image data, that is, fogging of an unnecessary background. Background color removing processing is executed by a matrix operation of a size of 3×8, or a one-dimensional look up table (LUT), for example.

Reference numeral 162 designates a monochrome generating unit which converts color image data into monochrome data, and converts color image data, for example, RGB data into gray (Gray) monochrome at the time of printing as monochrome. For example, a matrix operation of a size of 1×3 for multiplying RGB by an arbitrary constant to convert it into a gray signal is performed.

Reference numeral 163 designates an output color correcting unit which makes color correction in correspondence with the characteristics of the printer unit 300 which outputs image data. For example, processing by a matrix operation of a size of 4×8, and direct mapping are executed.

Reference numeral 164 designates a filter processing unit which arbitrarily corrects the spatial frequency characteristic of image data, and executes processing of convolution operation of a size of 7×7, for example.

Reference numeral 165 designates a gamma correcting unit which makes gamma correction in correspondence with the characteristics of the printer unit 300 which outputs, and usually uses a one-dimensional look up table (LUT).

Reference numeral 166 designates a nonlinear processing unit which executes processing for suppressing the toner use amount when a toner saving mode is effective, in addition to show-through prevention processing.

Reference numeral 167 designates a pseudo halftone processing unit which performs any pseudo intermediate gradation processing in correspondence with the number of gradations of the printer unit 300 which outputs, and executes any screen processing such as binarization and 32-arization and error dispersion processing.

The processing in the printer image processing unit 160 does not have necessarily use all from the aforementioned background color removing unit 161 to the pseudo halftone processing unit 167, and the other image processing modules may be added. Further, the sequence of processing of the background color removing unit 161 to the pseudo halftone processing unit 167 is only an example, and each processing can be executed in any sequence.

In the present embodiment, the case of a low visibility bar code which is one kind of electronic watermark will be described as an example of a two-dimensional code.

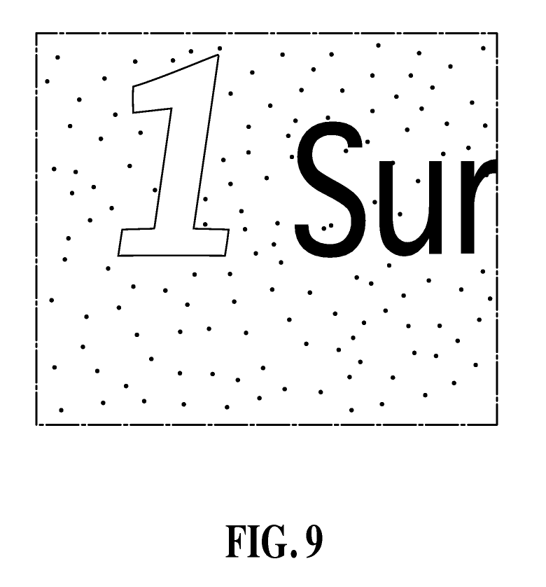

FIG. 9 is a partial enlarged view of a document image to which a low visibility bar code is added. In the typical use mode of the additional image like this, microscopic dots for expressing encoded information are arranged over the entire document image.

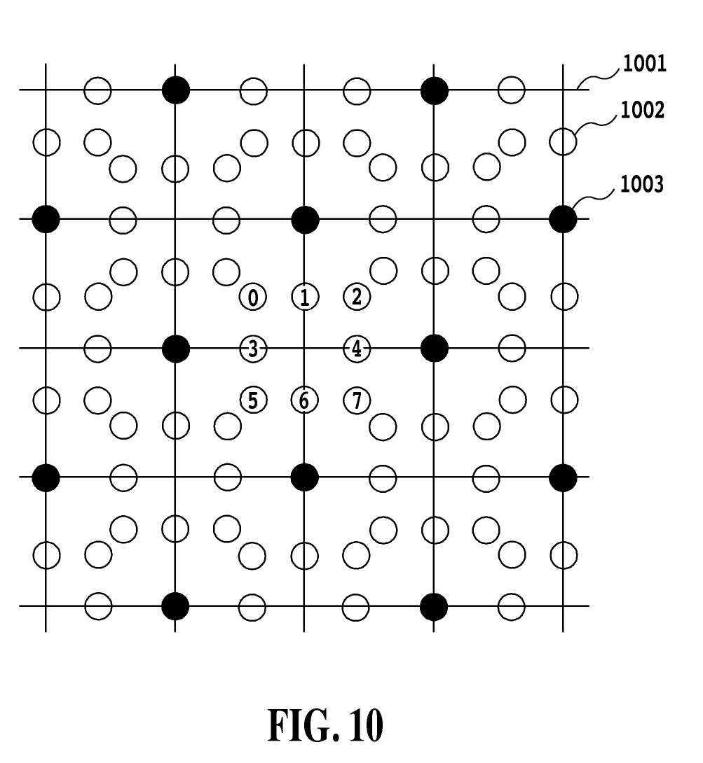

FIG. 10 is a view showing an example of an arrangement pattern of dots in the low visibility bar code. A dot 1003 shown by a black circle is a positioning dot which is fixed on an intersection point (grid point) of a virtual grid (lattice-shaped pattern expressed by longitudinal and lateral straight lines). A dot 1002 shown by a white circle shows the position in which a data dot expressing the information by the shifting direction from the grid point (shifting direction of the dot position) can be arranged. In this example, eight positions are specified around one grid point in advance, and the information from 0 to 7 is expressed depending on which position a dot is located in. More specifically, the dot is formed in any one of the positions 0 to 7, and information is expressed by the position of the dot. As is obvious from FIG. 10, the data dot 1002 is arranged on the virtual grid when the dot 1002 shows the information of 1, 3, 4 and 6, and at the time of showing the information of 0, 2, 5 and 7, the data dot 1002 is not arranged on the virtual grid. 100% of the positioning dots which constitute 50% of the total number of dots are disposed on the virtual grid, and about 50% of the data dots which constitute 50% of the total number of dots (the case of showing the information of 1, 3, 4 and 6) are arranged on the virtual grid. Therefore, the number of dots which are arranged on the virtual grid out of all the dots is probabilistically about 75% (0.5×1+0.5×0.5=0.75). In the present invention, by using the geometrical structure characteristic, even if a document image is reduced, there is generated a reduced image from which the content of the original document image is easily grasped.

Next, an information analyzing unit 131 in the additional image processing unit 130 will be described.

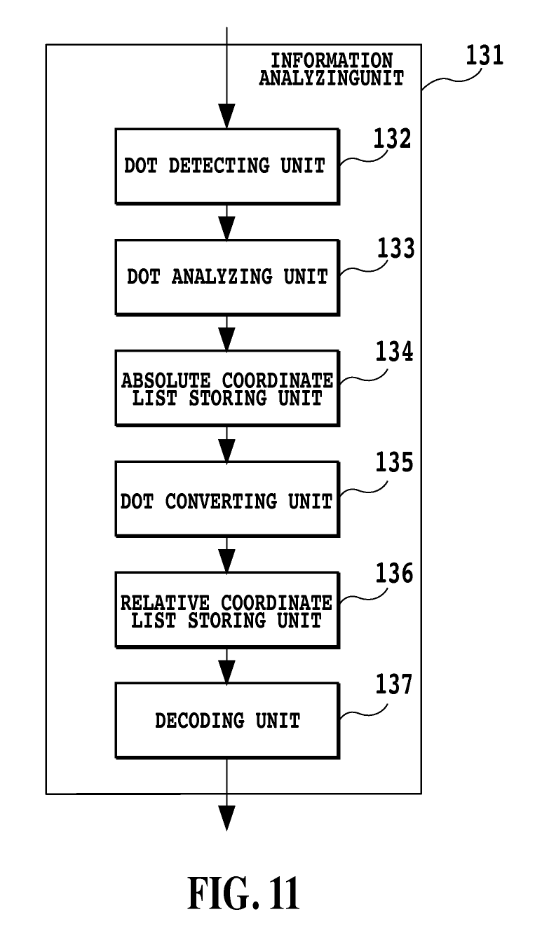

FIG. 11 is a block diagram showing elements constituting the information analyzing unit 131. The information analyzing unit 131 detects/analyzes a two-dimensional code which is an additional image.

Reference numeral 132 designates a dot detecting unit which detects all dots from the image including the additional image. Each of the dots which are detected is converted into coordinates.

Reference numeral 133 designates a dot analyzing unit which removes dots that can not constitute the additional image from the dots detected in the dot detecting unit 132.

Reference numeral 134 designates an absolute coordinate list storing unit which generates and stores an absolute coordinate list with respect to the output result of analysis in the dot analyzing unit 133, that is, each of the dots which remain after the dots which can not constitute the additional image are removed.

Reference numeral 135 designates a dot converting unit which detects a rotation angle and grid space from the absolute coordinate list stored in the absolute coordinate list storing unit 134 to obtain (convert the absolute coordinates into relative coordinates) the relative coordinates from the grid point (positioning dot) with respect to each of the remaining dots.

Reference numeral 136 designates a relative coordinate list storing unit which stores the relative coordinates of each of the dots obtained in the dot converting unit 135.

Reference numeral 137 designates a decoding unit which reads (decodes) information hidden as additional information from the relative coordinates of each of the dots and outputs the information. The decoding unit 137 executes the processing of imaging the obtained additional information. More specifically, since the information encoded by the dots expresses character codes, the decoding unit 137 also executes processing of converting the character codes into character images.

First, the dot detecting unit 132 receives the image read by the scanner unit 200 in the format of a multilevel monochrome image. The information by the additional image is embedded by the binary dots. However, due to influences such as the print characteristics at the time of embedding, the handling of the printed sheet and the optical characteristics at the time of scanning, the image which is read by the scanner unit 200 is received in the state in which the dots are microscopically distorted. More specifically, due to positional deviation and density unevenness of the dots, the information is likely to be inaccurate. In order to eliminate such influence, detection precision is enhanced by detecting the dots, and recognizing the position of the center of gravity of the detected dots as the absolute coordinates of each of the dots.

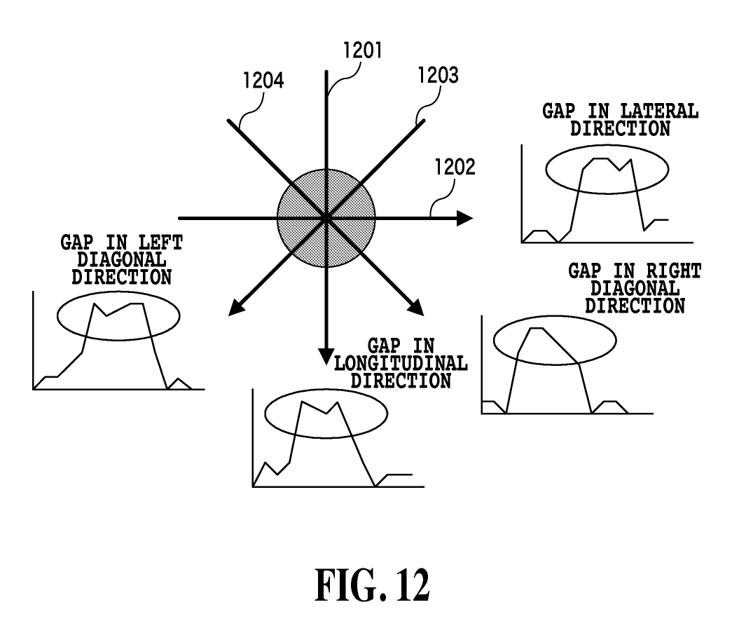

FIG. 12 is a diagram explaining the detecting method of the dots in the dot detecting unit 132.

In order to detect dots, inspection of gaps is carried out from four directions for the image. Reference numerals 1201 to 1204 designate directions at the time of inspection of presence and absence of dots. With the diameter of a dot assumed to be usually about two pixels, for example, the detection result of the longitudinal direction 1201 is “white”, “white”, “black, “black”, “white” and “white”, the black portions can be assumed to be dots. However, with only this, the possibility of being the line in the lateral direction can not be eliminated. Similarly, even when the possibility of being dots is determined by only the inspection of the lateral direction 1202, there is also the possibility of being actually the line in the longitudinal direction. In the present embodiment, inspection precision is enhanced by performing inspection of dots for four of the longitudinal, lateral, diagonally right and diagonally left directions. More specifically, when the detection result that there is the possibility of being dots in all the directions of 1201 to 1204 is given in a certain area, it is determined that a dot is present in that position.

Next, a detail of the processing executed in the dot analyzing unit 133 will be described.

By definition, all the dots that are detected in the dot detecting unit 132 are not necessarily the dots constituting the low visibility bar code. For example, such dots may be the dots for expressing a halftone dot, voiced sound symbols of hiragana characters and the like included in the document image. Such dots that do not constitute a low visibility bar code can not be thinned out in the thinning processing which will be described later. Therefore, the dots expressing the halftone dot and the like need to be removed from the detected dots.

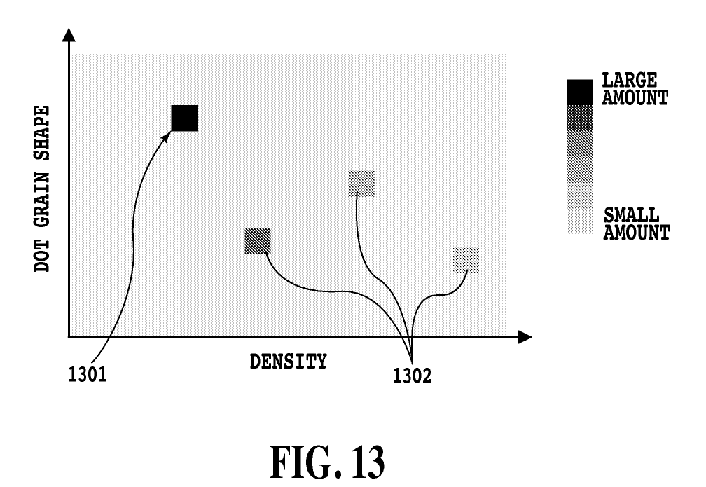

FIG. 13 is a graph for explaining the principle of removing the dots, which can not constitute a low visibility barcode, from the dots detected by the dot detecting unit 132.

The grain shape of the dot is plotted in the axis of ordinates, the density of the dot is plotted in the axis of abscissa, and the histogram showing the frequency of dots in the density of the point is shown. It is shown that the higher (darker) the density of the histogram, the higher the frequency of appearance. Here, in the case of the dots of the low visibility bar code, at the time of being embedded, the dots are embedded by making the grain shapes and densities of the dots uniform, and therefore, the peak of the frequency of appearance appears in the narrow range on the graph (1301). Meanwhile, in the case of the dots of the halftone dot and the like, the grain shapes and the densities are not normalized, and therefore, the dots appear sparsely in the wide range on the graph. Therefore, the frequency is relatively low (1302). By using this characteristic, the position where a high peak is shown in a narrow range is determined as the dot of a low visibility code, and the dots other than this dot are removed. The absolute coordinate list is created for the absolute coordinates of the dots which are determined as the dots of the low visibility code (positional information of each of the dots on the absolute coordinates), and the absolute coordinate list is stored in the absolute coordinate list storing unit 134.

As above, by the processing of removing the halftone dots and the like, in the absolute coordinate list, substantially only the dots of the low visibility code are printed.

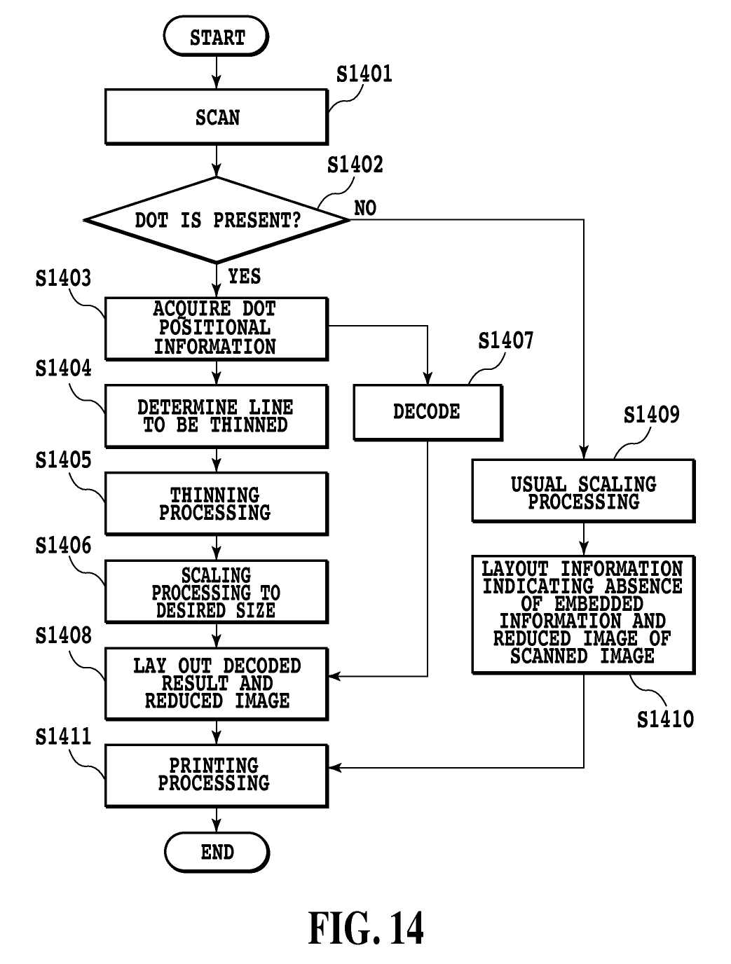

FIG. 14 is a flowchart showing a series of processing steps from scanning to printing of a document in the digital multi function peripheral 001 according to the present embodiment. In concrete, an example of the case of scanning a document, analyzing the contents of the additional information embedded in the document, and performing report print of the analysis result will be described.

First, in step 1401, the scanner unit 200 scans a document which is set, based on the instruction (instruction of starting analysis of embedded information and a job of report print) from a user through the operation unit 400. The image data which is obtained by scanning the document is inputted in the control unit 100 through the scanner I/F 113. After predetermined processing is executed to the image in the scanner image processing unit 150 in the control unit 100, the image data is compressed in the compression unit 112, which is temporarily stored in the RAM 107. Thereafter, the image data is decompressed in the decompression unit 121, which is inputted in the additional image processing unit 130.

In step 1402, the dot detecting unit 132 in the additional image processing unit 130 executes the aforementioned dot detection processing to the inputted image data, and determines whether or not the dots are present in the image.

When it is determined that the dots are not present, usual scaling processing is executed to the image data in step 1409. More specifically, the determination result that the dots are not present is reported to the CPU 103 through the system bus 101, and by the command from the CPU 103, the image data which is temporarily stored in the RAM 107 is inputted in the scaling unit 129 through the decompression unit 121. In the scaling unit 124, the usual scaling processing is executed to the image data, and the image data is reduced to be in a size for report print (for example, size of 10% in length and width), whereby a reduced image is obtained.

In step S1410, the synthesizing unit 128 allocates the obtained reduced image and a character image indicating absence of additional information (for example, “embedded additional information is absent.”, etc.) in the same page. More specifically, one sheet of the image in which the reduced image and the character image are arranged in predetermined areas in the same page is generated.

Meanwhile, when it is determined that the dot is present in step S1402, the process goes to step 1403.

In step 1403, the dot analyzing unit 133 in the additional image processing unit 130 executes the aforementioned analysis processing to generate and print the absolute coordinate list. More specifically, the dot analyzing unit 133 acquires the positional information (coordinates) of the dots which constitute the additional image.

Subsequently, the process of generating a reduced image (step 1404 to step 1406) and the process of decoding the encoded additional image (step 1407) are executed in parallel.

First, the processing of generating the reduced image will be described.

In step 1404, the thinning unit 129 refers to the generated absolute coordinate list, and determines the line where many dots are present as a line to be thinned. In detail, the thinning unit 129 calculates how many dots are located on the line from the absolute coordinate list with respect to each of the longitudinal and lateral lines along the virtual grid, and determines the line where many dots are statistically located as the line to be thinned.

Subsequently, in step S1405, the thinning unit 129 executes processing of thinning the pixels of the line to be thinned, which is determined in step 1404, from the image data (image data inputted in the additional image processing unit 130 in step S1402).

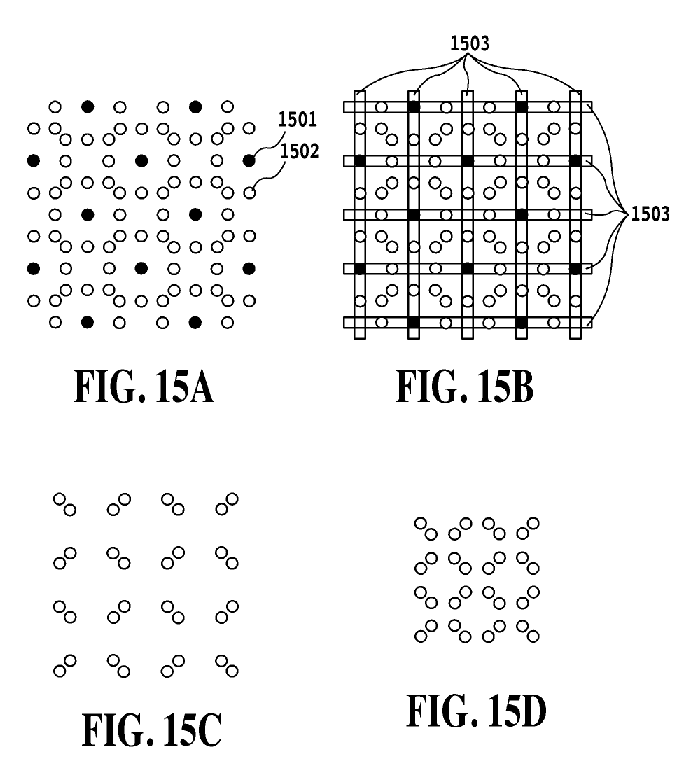

FIG. 15A to 15B are view visually explaining the principle of the thinning processing.

As described also in FIG. 10, reference numeral 1501 of FIG. 15A designates a positioning dot arranged on the grid point of the virtual grid, and reference numeral 1502 designates a position where a data dot expressing information by the positional deviation from the grid point can be arranged. Reference numeral 1503 designates a line to be thinned which is determined in step 1404. The width of the line 1503 to be thinned is determined in correspondence with the sizes of the dots 1501 and 1502. For example, the sizes of the dots constituting the additional image detected in the dot analyzing unit are measured and the average thereof is obtained. Further, the average value is multiplied by α (for example, 1.1 times) or the like, and thereby, the width of the line to be thinned is determined. Subsequently, the pixels of the line to be thinned are removed from the entire image, and thereby, only the dots arranged at the data dots shown in FIG. 15C remain. As a result, output of the thinning processing in step S1405 is in the form showing in FIG. 15D.

By the above processing, the image data in which the number of dots constituting the low visibility bar code is significantly reduced is generated. The image data subjected to the thinning processing is inputted in the scaling 124.

In step S1406, the scaling unit 124 executes processing of reducing (or enlarging) the image data into the size for report print, and the image with the number of pixels defined in accordance with use purpose is generated. As the variable magnification method, a well known method can be applied. For example, a nearest neighbor method which applies the values of necessary pixels of the original image directly to the output image by the number of the necessary pixels, a bi-cubic interpolation or bilinear method which determines the output pixel value by interpolation calculation by using the values of a plurality of pixels of the original image, and the like can be applied.

Next, the processing of decoding the encoded additional image will be described.

In step 1407, the additional image processing unit 130 executes the processing of each of the aforementioned dot converting unit 135, the relative coordinate list storing unit 136 and the decoding unit 137 to obtain the embedded information (additional information). The embedded information expresses a character code, and the processing of converting the character code into a character image is executed here, but this processing does not directly relate to the present invention. Therefore, a detail thereof will be omitted.

After the processing of generating the reduced image and the processing of decoding the encoded additional image are completed as above, the process goes to step 1408.

In step 1408, the synthesizing unit 128 allocates the image reduced for report print and the embedded information (character image) to predetermined positions in the same page. More specifically, the synthesizing unit 128 generates image data which links the reduced image generated in step 1406 to the decoded result in step 1407.

Finally, in step 1411, the printer unit 300 prints the image data to which layout processing is executed. Specially, the image data passes through the decompression unit 114 (since the image data is not originally compressed), and after the image data is converted into data for printing in the printer image processing unit 160, the data is transmitted to the printer unit 300 through the printer I/F 115. Subsequently, the printer unit 300 prints the image data to complete a series of processing steps.

In the present embodiment, the case of printing the generated image data is described, but the generated image data may be stored in the HDD 109 or the like for use at a later date. In such a case, the effect of the present invention of being capable of stably securing visibility of the original document on the reduced image is also exhibited.

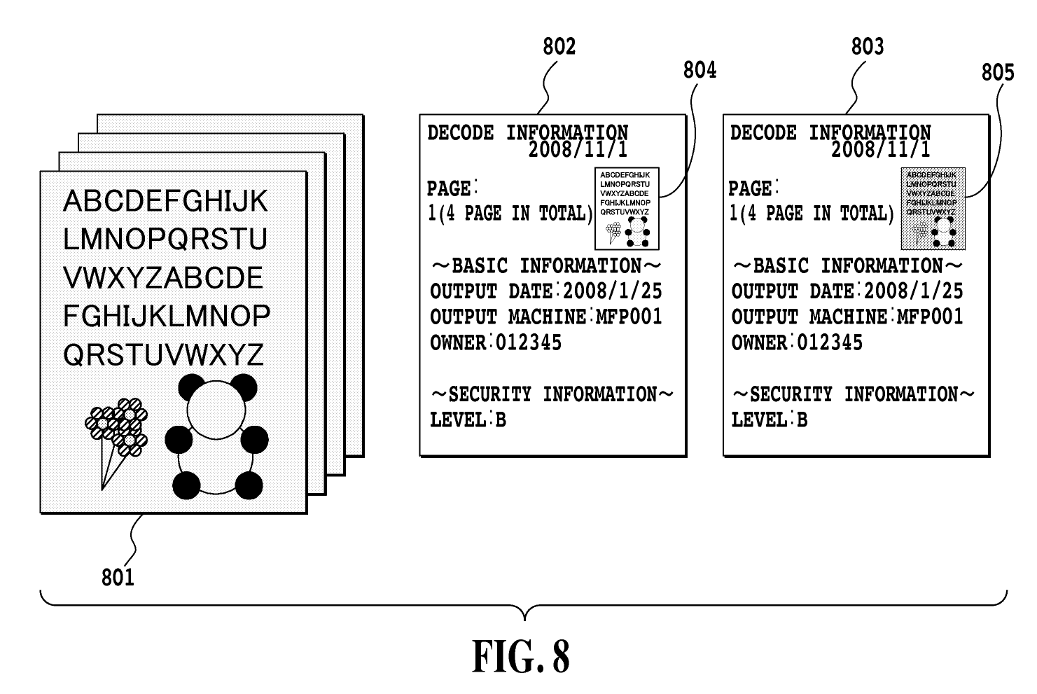

FIG. 8 is diagrams of comparing the case of printing a report print with a reduced image by using the digital multi function peripheral according to the present embodiment with the case of printing the report print by using the conventional technology. Reference numeral 801 designates an original document in which low visibility bar codes expressed by collections of dots are present in the entire document. Reference numeral 802 designates a report print which is printed by applying the present invention, and reference numeral 803 designates a report print printed by applying the conventional technology. Upon comparing thumbnail images 804 and 805 which are generated by reducing the original image 801, the difference of them is obvious at a glance. The image 805 appears to be dark as a whole since the dots constituting the low visibility bar codes are emphasized, and as a result, visibility becomes poor and the characters and drawings in the thumbnail image are difficult to recognize. Meanwhile, the image 804 to which the present invention is applied appears to be white as a whole by thinning the dots constituting the low visibility bar codes, and as a result, the image has a good contrast of the characters and the drawings to the background in the thumbnail image, and has favorable visibility. Therefore, the content thereof can be instantaneously understood.

In the present embodiment, the case of a low visibility bar code is described as an example, but the present invention is not limited to this. The present invention is widely applicable to the copy-forgery-inhibited pattern and the N-dimensional code which will be described later only if it is a technique of coding constructed by the collection of dots. Especially when dots are arranged as having substantial periodicity at a constant degree, the effect becomes remarkable.

### Second Embodiment

In the first embodiment, the mode of detecting the dots constituting the low visibility codes prior to the processing of thinning the dots is described with the case of taking the low visibility bar code as an example of a two-dimensional code. In the present embodiment, a mode of performing no detection of dots prior to the processing of thinning the dots will be described with the case of taking a copy-forgery-inhibited pattern as an example.

The components common to the first embodiment are referred to as the same drawings and reverence numerals, and a detail thereof will be omitted.

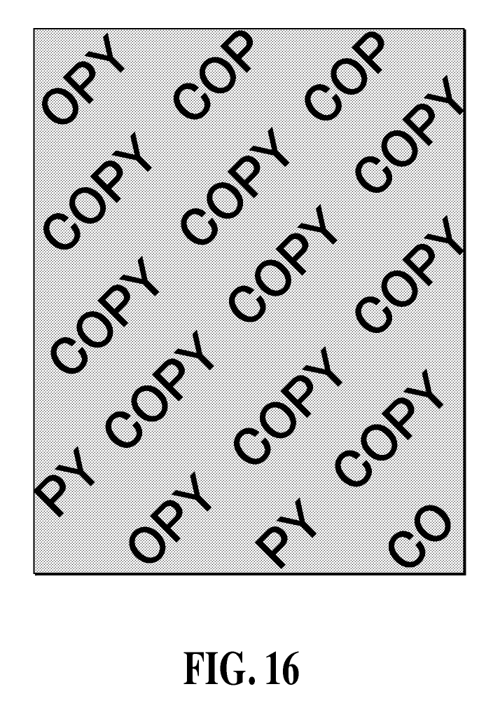

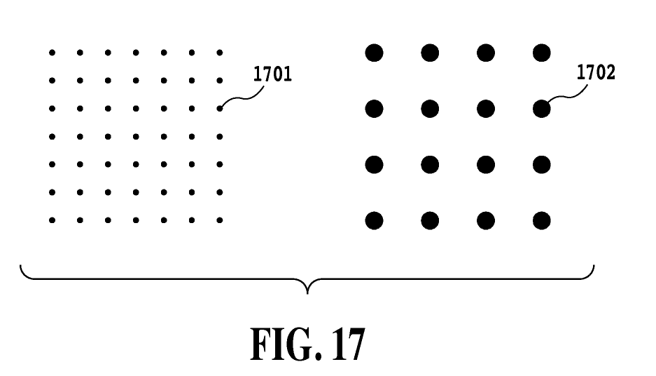

First, the outline of a copy-forgery-inhibited pattern will be described by using FIGS. 16 and 17.

FIG. 16 is an example of an image to which a copy-forgery-inhibited pattern is added. The characteristic of the copy-forgery-inhibited pattern is in that the average densities of the area where small dots are arranged and the area where large dots are arranged are made the same. Thereby, the image containing two kinds of the areas which are difficult to distinguish visually is formed and the area of the small dots is not reproduced when the document is copied, whereby characters such as “copy” can be allowed to stand out in the copied object.

FIG. 17 is an arrangement example of dots in the copy-forgery-inhibited pattern. In the area (left) constituted by small dots 1701, dots are arranged with a density higher than in the area constituted by large dots 1702. Many copy-forgery-inhibited patterns are generally formed by periodically arranging dots as shown in FIG. 17. In the present embodiment, the reducing method is realized by using the characteristic of the periodic arrangement of dots.

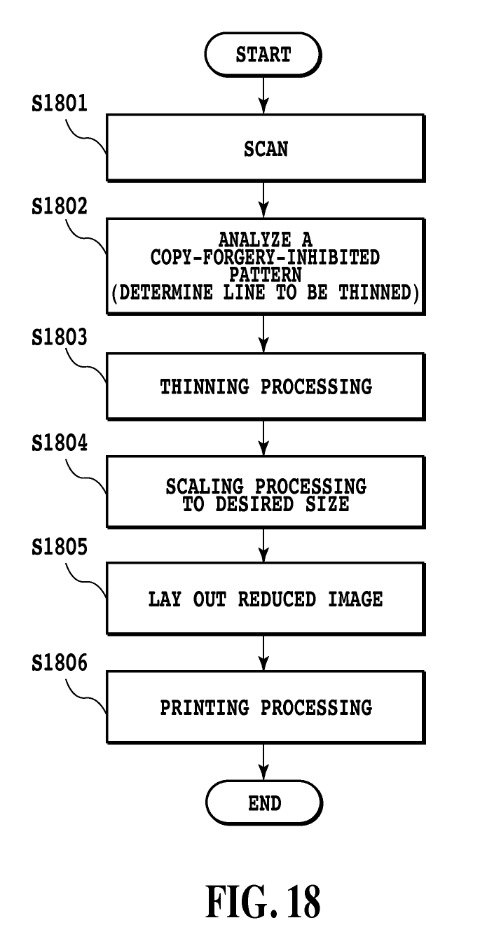

FIG. 18 is a flowchart showing a series of processing steps from scanning to printing of a document in the digital multi function peripheral 001 according to the present embodiment.

First, in step 1801, a document is scanned. After the image data is inputted in the additional image processing unit 130, the additional image processing unit 130 analyzes the copy-forgery-inhibited pattern by an internal module (copy-forgery-inhibited pattern analyzing unit) not illustrated, and determines the line to be thinned where dots constituting the copy-forgery-inhibited pattern are present with a high probability, in step 1802.

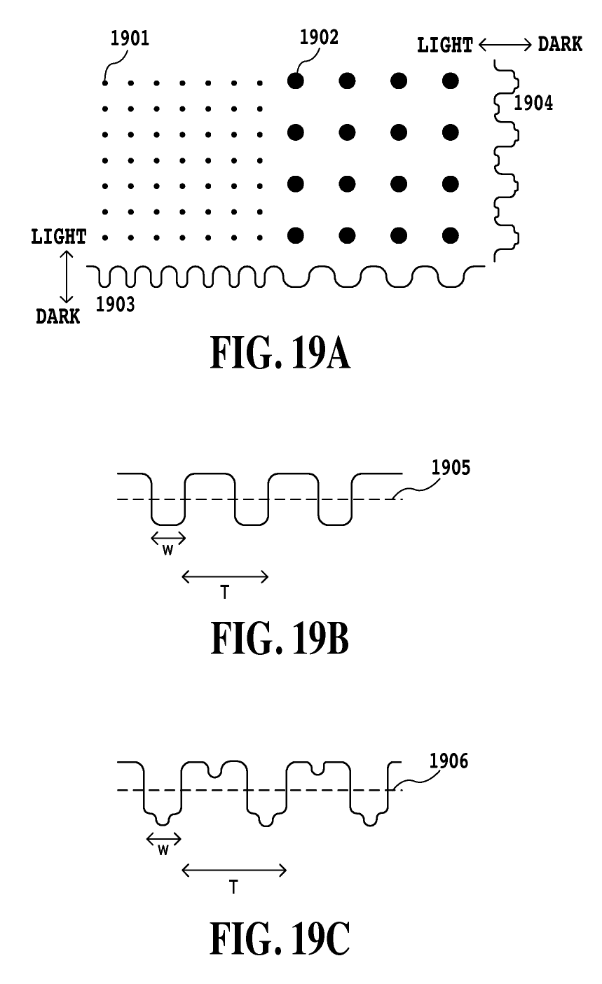

FIGS. 19A to 19C are diagram explaining the principle of the processing of analyzing the copy-forgery-inhibited pattern.

As described above, the copy-forgery-inhibited pattern is constructed of two areas that are an area constituted by small dots 1901 and an area constituted by large dots 1902. In order to simply determine the line where these dots are located, the pixel values are accumulated respectively with respect to a plurality of arranging directions (for example, the longitudinal direction and the lateral direction) where dots periodically appear to acquire waveform data 1903 and 1904 showing the distribution of the accumulated values as shown in FIG. 19A. The periodicity of the waveform data is used to detect the line where dots are present in the entire image. For example, in the case of the waveform data of FIG. 9B, the period at which the dot is present can be determined as T, and the width of the dot can be determined as w. From the period T and the dot width w which are obtained, the position and the width of the line to be thinned are determined. Further, in the case of the line where small dots and large dots coexist, the waveform data as shown in FIG. 19C is obtained. In this case, the period and the width w can be obtained with the portion where both a small dot and a large dot are present as the reference. However, in the actual image, the dots other than the dots constituting the copy-forgery-inhibited pattern are also present, and therefore, the waveform data is distorted. Therefore, in order to obtain the waveform suitable for determination, the average value (the value shown by the broken line of 1905 or 1906) is set as the reference (threshold value), the accumulated values are divided into the portion beyond the reference and the portion below the reference, and the wavelength data thus obtained is used.

As above, the position and the width of the line having high probability of presence of dots constituting the copy-forgery-inhibited pattern are obtained to determine the line to be thinned.

In step 1803, the thinning unit 129 executes processing of thinning the longitudinal and lateral lines to be thinned, which are determined in step 1802, to the image data temporarily stored in the RAM 107, and generates the image data from which the dots constituting the copy-forgery-inhibited pattern are removed.

The generated image data is inputted in the scaling unit 124, and is converted into a desired image size (step S1804).

Subsequently, as in the first embodiment, the reduced image is arbitrarily laid out in step 1805. On this occasion, in order to make addition of the copy-forgery inhibited pattern to the original image data recognizable, the information such as a message, for example, “original image includes a copy-forgery-inhibited pattern.” may be located around the reduced image. In this case, for example, processing of incorporating the information showing the addition of the copy-forgery-inhibited pattern into the generated image data or processing of linking the information showing the addition of the copy-forgery-inhibited pattern with the image data as separate data is executed. Thereafter, in step 1806, printing processing is executed by using the generated image data.

Further, as in the case of embodiment 1, the image data generated as described above may be stored in the HDD 109 or the like for use at a later date or the like.

### Other Embodiments

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-018731, filed Jan. 29, 2009, which is hereby incorporated by reference herein in its entirety.

1. An image processing apparatus, comprising:
a reducing unit configured to reduce an original image; and
a deleting unit configured to delete an additional image from the original image, when the original image includes the additional image and information in the additional image will be hidden as a result of reducing the original image by the reducing unit.

2. The image processing apparatus according to claim 1, wherein the additional image is constructed of dots arranged to have substantial periodicity; and
the deleting unit deletes the additional image by thinning out pixels of a line where the dots are located from the original image.

3. The image processing apparatus according to claim 2, further comprising:
an acquiring unit configured to acquire positional information of the dots constituting the additional image; and
a determining unit configured to determine a line where the dots are located based on the acquired positional information.

4. The image processing apparatus according to claim 3, further comprising:
a removing unit configured to remove dots which can not constitute the additional image from the original image.

5. The image processing apparatus according to claim 2, further comprising:
a unit configured to accumulate a pixel value with respect to each of a plurality of arranging directions where the dots of the additional image periodically appear to acquire distribution of the accumulation values; and
a determining unit configured to determine a line where the dots are located according to the acquired distribution of the accumulation values.

6. The image processing apparatus according to claim 1,
wherein the additional image is a copy-forgery-inhibited pattern or a two-dimensional code.

7. An image processing method, comprising:
a reducing step of reducing an original image; and
a deleting step of deleting an additional image from the original image, when the original image includes the additional image and information in the additional image will be hidden as a result of reducing the original image in the reducing step.

8. A program on a computer readable medium for an image processing method, the method comprising the steps of:
reducing an image original image; and
deleting an additional image from the original image, when the original image includes the additional image and information in the additional image will be hidden as a result of reducing the original image in the reducing step.
